(19) United States
(12) Patent Application Publication
(10) Pub. No.: US 2012/0311423 A1
(43) Pub. Date: Dec. 6, 2012

(54) Dynamically Controlling Collisions of Form Controls in an Electronic Document

(75) Inventors: Benjamin Hodes, Seattle, WA (US); Jordan Mandel-Iaia, Seattle, WA (US); Stephen I. Lesser, Redmond, WA (US)

(73) Assignee: Microsoft Corporation, Redmond, WA (US)

(21) Appl. No.: 13/154,188

(22) Filed: Jun. 6, 2011

(51) Int. Cl. G06F 17/00

(52) U.S. Cl. 715/221

(57) ABSTRACT

Collisions resulting from the movement of form controls in an electronic document may be dynamically controlled. A user interface may be displayed on a computer which includes a design surface for manipulating the form controls in the electronic document. A selection of one or more form controls in the electronic document may be received by the computer. The selected form controls may be moved over the design surface from an original location. Non-selected form controls on the design surface may be moved to a new location on the design surface upon colliding with the selected form controls being moved. The non-selected form controls may further be aligned to a hidden grid within the design surface after being moved.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Various computer software applications allow end users to create forms and tables with controls which may be utilized for receiving data in an organized fashion. For example, an electronic commerce website may utilize web-based application forms for obtaining customer name and address information prior to creating an order. While the aforementioned computer software applications enable users to create forms, they fail to provide adequate usability guidelines with respect to the layout of controls on a page surface. For example, initial control layouts are often not aligned properly and/or are scattered over a page surface in a haphazard manner. Moreover, the creation table layouts utilizing the aforementioned computer software applications also provide a poor user experience as they require users to define layouts through the splitting and merging of table cells. It is with respect to these considerations and others that the various embodiments of the present invention have been made.

### SUMMARY

This summary is provided to introduce a selection of concepts in a simplified form that are further described below in the Detailed Description. This summary is not intended to identify key features or essential features of the claimed subject matter, nor is it intended as an aid in determining the scope of the claimed subject matter.

Embodiments are provided for dynamically controlling collisions of form controls in an electronic document. On a computer, a user interface may be displayed which includes a design surface for manipulating the form controls in the electronic document. The computer may receive a selection of one or more form controls in the electronic document. The selected form controls may be moved over the design surface. As the selected form controls are moved over the design surface, non-selected form controls on the design surface are moved away from their original locations upon colliding with the selected form controls. The non-selected form controls may be aligned to a hidden grid within the design surface after being moved.

These and other features and advantages will be apparent from a reading of the following detailed description and a review of the associated drawings. It is to be understood that both the foregoing general description and the following detailed description are illustrative only and are not restrictive of the invention as claimed.

### BRIEF DESCRIPTION OF THE DRAWINGS

FIG. 1 is a flow diagram illustrating a routine for dynamically controlling collisions of form controls in an electronic document, in accordance with an embodiment;

FIG. 2 is a block diagram of a hidden grid utilized in aligning form controls in an electronic document, in accordance with an embodiment;

FIG. 3 is a block diagram of a hidden grid showing a process of determining grid locations for moving form controls in an electronic document, in accordance with an embodiment;

FIG. 4A is a computer screen display of a user interface design surface showing form controls prior to being moved, in accordance with an embodiment;

FIG. 4B is a computer screen display of a user interface design surface showing the collision of selected form controls with non-selected form controls, in accordance with an embodiment;

FIG. 4C is a computer screen display of a user interface design surface showing the alignment of selected form controls following a collision with non-selected form controls, in accordance with an embodiment;

FIG. 5A is a computer screen display of a user interface design surface showing the collision of a selected form control with non-selected form controls, in accordance with an embodiment;

FIG. 5B is a computer screen display of a user interface design surface showing the alignment of a selected form control following a collision with non-selected form controls, in accordance with an embodiment;

FIG. 6A is a computer screen display of a user interface design surface showing the collision of a selected form control with non-selected form controls, in accordance with an alternative embodiment;

FIG. 6B is a computer screen display of a user interface design surface showing the alignment of a selected form control following a collision with non-selected form controls, in accordance with an alternative embodiment; and

FIG. 7 is a block diagram illustrating a computing environment which may be utilized for dynamically controlling collisions of form controls in an electronic document, in accordance with an embodiment.

### DETAILED DESCRIPTION

Embodiments are provided for dynamically controlling collisions of form controls in an electronic document. On a computer, a user interface may be displayed which includes a design surface for manipulating the form controls in the electronic document. The computer may receive a selection of one or more form controls in the electronic document. The selected form controls may be moved over the design surface. As the selected form controls are moved over the design surface, non-selected form controls on the design surface are moved away from their original locations upon colliding with the selected form controls. The non-selected form controls may be aligned to a hidden grid within the design surface after being moved.

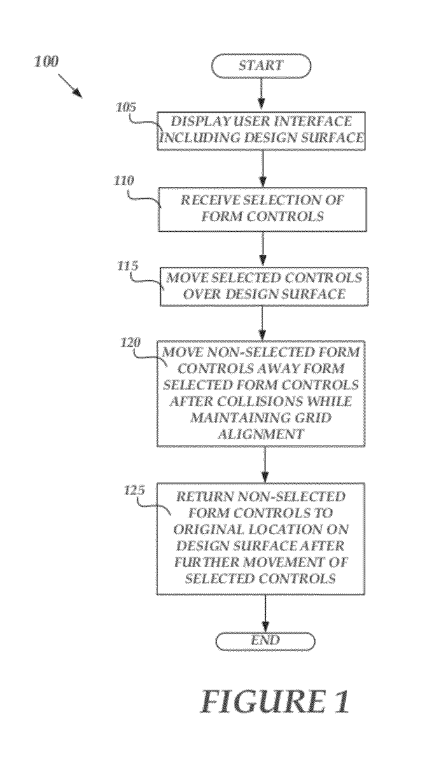

FIG. 1 is a flow diagram illustrating a routine illustrating a routine 100 dynamically controlling collisions of form controls in an electronic document, in accordance with an embodiment. When reading the discussion of the routine presented herein, it should be appreciated that the logical operations of various embodiments of the present invention are implemented (1) as a sequence of computer implemented acts or program modules running on a computing system and/or (2) as interconnected machine logical circuits or circuit modules within the computing system. The implementation is a matter of choice dependent on the performance requirements of the computing system implementing the invention. Accordingly, the logical operations illustrated in FIG. 1 and making up the various embodiments described herein are referred to variously as operations, structural devices, acts or modules. It will be recognized by one skilled in the art that these operations, structural devices, acts and modules may be implemented in software, in firmware, in special purpose digital logical, and any combination thereof without deviating from the spirit and scope of the present invention as recited within the claims set forth herein.

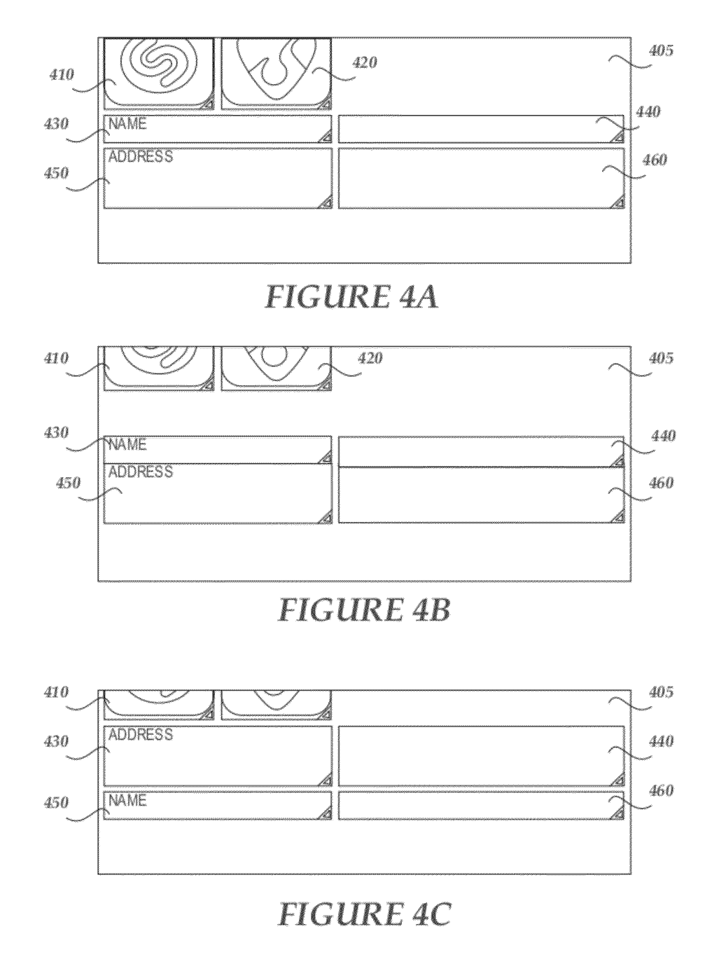

The routine 100 begins at operation 105, where a form application executing on a computer displays a user interface including a design surface for manipulating form controls in an electronic document. In accordance with an embodiment, the form application may comprise a software application for creating forms and/or tables which may be published in Web pages via a shared services platform. An illustrative form application may include the OFFICE-ACCESS SERVICES platform from Microsoft Corporation of Redmond, Wash. It should be appreciated, however, that form applications from other manufacturers may also be utilized in accordance with the various embodiments described herein. Illustrative design surfaces which may be utilized in the various embodiments described herein are shown in FIGS. 4-6, which will be described in detail below.

From operation 105, the routine 100 continues to operation 110, where the form application executing on the computer receives a selection of one or more form controls in the electronic document. In accordance with various embodiments, the form controls may include, without limitation, labels, text boxes, image controls, web page controls, and combo boxes. For example, a user may select adjoining “Name” label and/or “Name” text box form controls for moving over the user interface design surface. It should be understood that in accordance with an embodiment, multiple form controls may be selected and moved simultaneously over the user interface design surface.

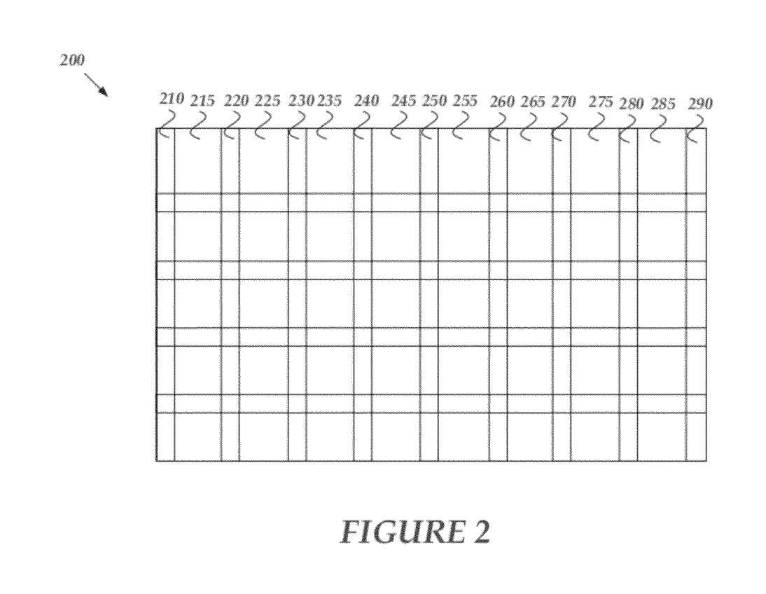

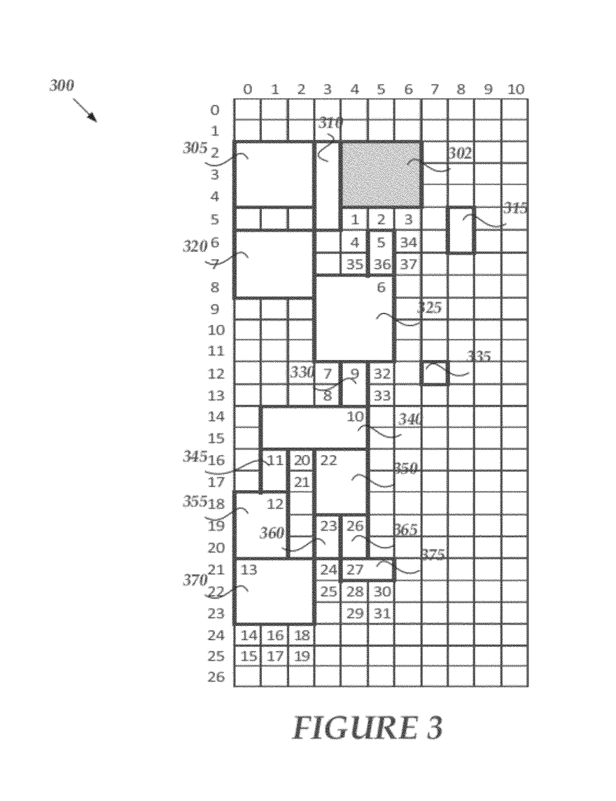

From operation 110, the routine 100 continues to operation 115, where the form application executing on the computer receives moves the selected form controls over the user interface design surface in the electronic document. It should be understood that the selected form controls may be moved in response to user input. In particular, the user may initiate a drag operation in the form application resulting in the selected form controls being dragged over the design surface. In accordance with various embodiments, the design surface may further comprise a hidden grid, which is not visible to the user, and which includes a number of grid cells for aligning the selected form controls on the design surface once the drag operation has been completed. As will be discussed in greater detail herein, the hidden grid may also be utilized to align other form controls on the design surface based on the locations of various grid cells. Illustrative diagrams showing the hidden grid and various grid cells which may be incorporated therein are shown in FIGS. 2-3, which will be described in detail below.

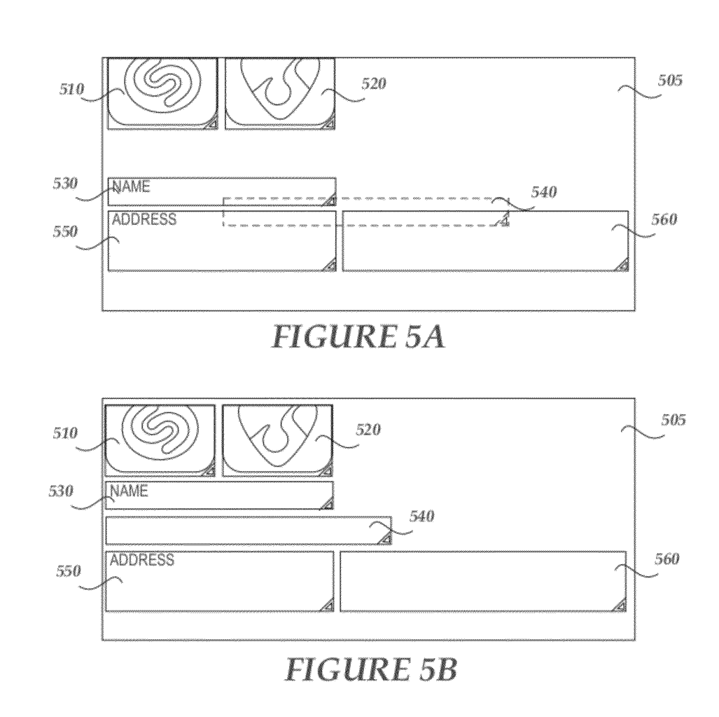

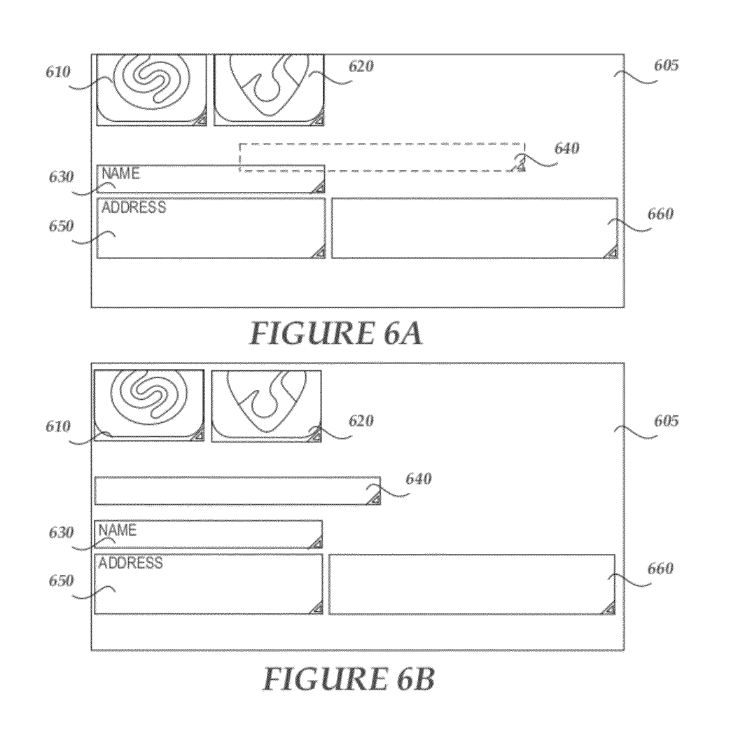

From operation 115, the routine 100 continues to operation 120, where the form application executing on the computer moves any non-selected form controls, which collide with the selected form controls being dragged across the design surface, away from the selected form controls (i.e., away from their original locations) while maintaining an alignment with the hidden grid. In particular, the form application may be configured to “bump” one or more non-selected form controls, which are occupying a location which a user wishes to place the selected form controls, to another location on the design surface. It should be understood that the new location for the “bumped” non-selected form controls may be determined based on a direction of encroachment on the non-selected form controls by the selected form controls. The direction of encroachment may be horizontal or vertical. For example, in accordance with an embodiment, the selected form controls may encroach upon the non-selected form controls horizontally such that the non-selected form controls are located on an upper half of the selected form controls. In this case, the form application may be configured to move or bump the non-selected form controls upwards on the design surface. Illustrative design surfaces illustrating the aforementioned example are shown in FIGS. 5A-5B which will be described in detail below. It should be understood however, that the form application may be configured to take into account the availability of space on the design surface in determining whether or not to bump the non-selected form controls upwards on the design surface. For example, with respect to the aforementioned embodiment, if the horizontal encroachment of the selected form controls occurs at the top of the design surface such that there is no available space to bump the non-selected form controls upwards, then the form application may be configured to move the non-selected form controls downwards on the design surface. In accordance with another embodiment, if the horizontal encroachment of the selected form controls is such that the non-selected form controls are located on a lower half of the selected form controls, then the form application may be configured to move or bump the non-selected form controls downwards on the design surface. Illustrative design surfaces illustrating the aforementioned example are shown in FIGS. 6A-6B which will be described in detail below. In accordance with another embodiment, if a selected form control being moved horizontally collides with a non-selected form control which is the same size as the selected from control, then the form application may be configured to move or bump the non-selected form control downwards on the design surface. In accordance with yet another embodiment, the selected form controls may encroach upon the non-selected form controls vertically. In this case, the form application may be configured to move or bump the non-selected form controls in a direction corresponding to the direction of the vertical encroachment. For example, if selected form controls are being moved in a downward direction on the design surface when they collide with non-selected from controls, then the form application may be configured to move or bump the non-selected from controls in an upward direction on the design surface. Illustrative design surfaces illustrating the aforementioned example are shown in FIGS. 4A-4C which will be described in detail below.

From operation 120, the routine 100 continues to operation 125, where the form application executing on the computer may be configured return any non-selected form controls to their original locations on the design surface after further movement of the selected form controls. In particular, “bumped” non-selected form controls may be automatically returned to their original locations when one or more selected form controls are moved so that they no longer occupy the space previously containing the non-selected form controls. From operation 125, the routine 100 then ends.

FIG. 2 is a block diagram of a hidden grid 200 (hereinafter referred to as the “grid 200”) utilized in aligning form controls in an electronic document, in accordance with an embodiment. The grid 200 may include “gutters” 210, 220, 230, 240, 250, 260, 270, 280 and 290 which separate columns 215, 225, 235, 245, 255, 265, 275 and 285. With respect to the grid 200, form controls may be placed in the spaces defined by the columns 215, 225, 235, 245, 255, 265, 275 and 285 and separated by the spaces defined by the gutters 210, 220, 230, 240, 250, 260, 270, 280. It should be understood that the combination of gutters and columns prevent form controls from overlapping each other and facilitate alignment of form controls on a design surface. In particular, the grid 200 may comprise a structure that defines where form controls may be placed on a design surface. The grid 200 may further be defined with the following position and placement rules: 1. The grid 200 starts at the top left of a form; 2. There is a left gutter before the first full column; 3. There is a right gutter after the last full column; 4. There are no gutters at the top of the grid; 5. Form controls may not be placed on top of each other; 6. Form controls may start at the right edge of a gutter; 6, Form controls may end at the left edge of a gutter; 7 Form controls may cross several gutters/columns. In accordance with an embodiment, the grid may comprise a fixed number of columns with each column having a column width (in pixels) which is twice that of a column height (in pixels). Each gutter in the grid may also have a gutter width (in pixels) which is greater than a gutter height. As a none limiting example, an illustrative grid 200 utilized in accordance with the various embodiments described herein may have the following characteristics: Number of Columns=22; Form Height=Infinite; Column Width=30 pixels; Column Height=15 pixels; Gutter Width=15 pixels; Gutter Height=10 pixels.

FIG. 3 is a block diagram of a hidden grid 300 showing a process of determining grid locations for moving form controls in an electronic document, in accordance with an embodiment. The hidden grid 300 includes a number of grid cells upon which are placed a selected form control 302 and non-selected form controls 305-375. As the selected from control 302 is moved over the hidden grid 300 (i.e., a design surface), the numbered grid cells 1-37 may be utilized to define an order of grid cells which are searched for available space to move the non-selected from controls 305-375 during a “bump.”

FIG. 4A is a computer screen display of a user interface design surface 405 showing form controls prior to being moved, in accordance with an embodiment. The user interface design surface 405 may include image controls 410 and 420, a Name label control 430, a Name text box control 440, an Address label control 450 and an Address text box control 460.

FIG. 4B is a computer screen display of the user interface design surface 405 showing the collision of selected form controls with non-selected form controls, in accordance with an embodiment. For example, a user may simultaneously select the Name label control 430 and the Name text box control 440 (i.e., the selected form controls) and drag them in a vertical downward direction towards the Address label control 450 and the Address text box control 460 (i.e., the non-selected form controls) on the user interface design surface 405 until the selected form controls collide (i.e., “bump”) with the non-selected form controls.

FIG. 4C is a computer screen display of the user interface design surface 405 showing the alignment of selected form controls following a collision with non-selected form controls, in accordance with an embodiment. As discussed above with respect to operation 120 in FIG. 1, the form application may be configured to move the Address label control 450 and the Address text box control 460 (i.e., the non-selected form controls) in an upward direction so that the Name label control 430 and the Name text box control 440 (i.e., the selected controls) may occupy the space previously occupied by the non-selected controls. Furthermore, it should be appreciated that the alignment of the form controls with respect to each other and with respect to the image controls 410 and 420 is maintained even after the form controls have been moved around on the user interface design surface 405.

FIG. 5A is a computer screen display of a user interface design surface 505 showing the collision of a selected form control with non-selected form controls, in accordance with an embodiment. The user interface design surface 505 may include image controls 510 and 520, a Name label control 530, a Name text box control 540, an Address label control 550 and an Address text box control 560. The Name text box control 540 (i.e., the selected form control) is shown as horizontally encroaching on the Name label control 530 such that the Name label control 530 (i.e., the non-selected form control) is located on an upper half of the selected form control. For example, a user may select the Name text box control 540 and drag it horizontally to the left over the user interface design surface 505 until it collides with or bumps the Name label control 530 in the manner discussed above.

FIG. 5B is a computer screen display of the user interface design surface 505 showing the alignment of a selected form control following a collision with non-selected form controls, in accordance with the alternative embodiment. As discussed above with respect to operation 120 in FIG. 1, the form application may be configured to move the Name label control 530 upwards on the user interface design surface 505 and the Name text box control 540 may then be moved into the space previously occupied by the Name label control 530.

FIG. 6A is a computer screen display of a user interface design surface 605 showing the collision of a selected form control with non-selected form controls, in accordance with an alternative embodiment. The user interface design surface 605 may include image controls 610 and 620, a Name label control 630, a Name text box control 640, an Address label control 650 and an Address text box control 660. The Name text box control 640 (i.e., the selected form control) is shown as horizontally encroaching on the Name label control 630 such that the Name label control 630 (i.e., the non-selected form control) is located on a lower half of the selected form control. For example, a user may select the Name text box control 640 and drag it horizontally to the left over the user interface design surface 605 until it collides with or bumps the Name label control 630 in the manner discussed above.

FIG. 6B is a computer screen display of the user interface design surface 605 showing the alignment of a selected form control following a collision with non-selected form controls, in accordance with the alternative embodiment. As discussed above with respect to operation 120 in FIG. 1, the form application may be configured to move the Name label control 630 downwards on the user interface design surface 605 and the Name text box control 640 may then be moved into the space previously occupied by the Name label control 630.

### Exemplary Operating Environment

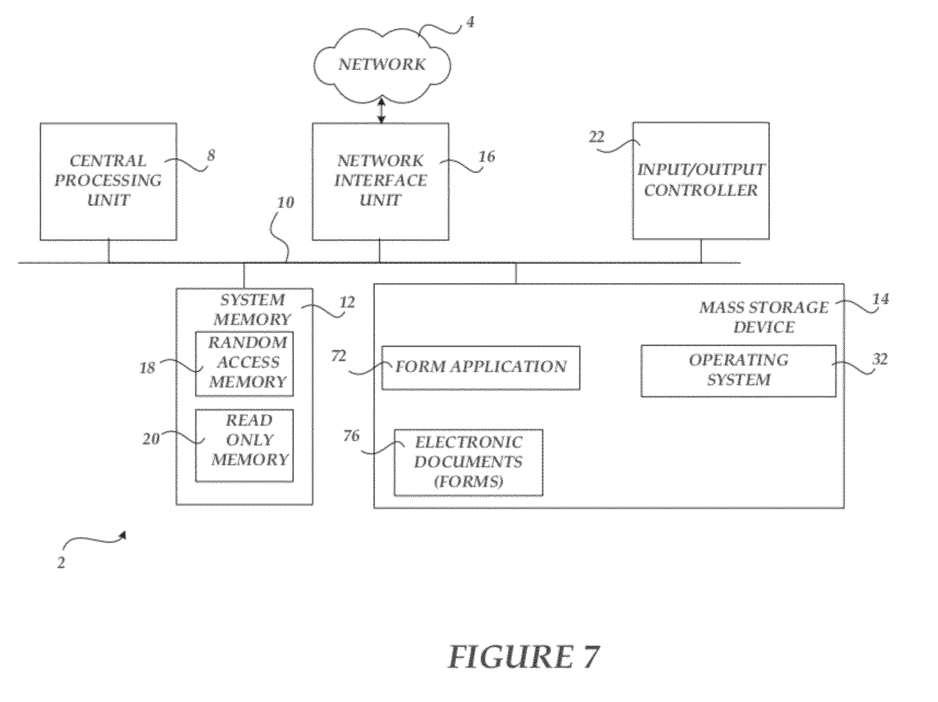

Referring now to FIG. 7, the following discussion is intended to provide a brief, general description of a suitable computing environment in which various illustrative embodiments may be implemented. While various embodiments will be described in the general context of program modules that execute in conjunction with program modules that run on an operating system on a computer, those skilled in the art will recognize that the various embodiments may also be implemented in combination with other types of computer systems and program modules.

Generally, program modules include routines, programs, components, data structures, and other types of structures that perform particular tasks or implement particular abstract data types. Moreover, those skilled in the art will appreciate that the various embodiments may be practiced with a number of computer system configurations, including hand-held devices, multiprocessor systems, microprocessor-based or programmable consumer electronics, minicomputers, mainframe computers, and the like. The various embodiments may also be practiced in distributed computing environments where tasks are performed by remote processing devices that are linked through a communications network. In a distributed computing environment, program modules may be located in both local and remote memory storage devices.

FIG. 7 shows a computer 2 which may include a general purpose desktop, server or other type of computer capable of executing one or more application programs. The computer 2 includes at least one central processing unit 8 (“CPU”), a system memory 12, including a random access memory 18 (“RAM”), a read-only memory (“ROM”) 20 and a system bus 10 that couples the memory to the CPU 8. A basic input/output system containing the basic routines that help to transfer information between elements within the computer, such as during startup, is stored in the ROM 20.

The computer 2 further includes a mass storage device 14 for storing an operating system 32, a form application 72, and electronic documents 76 which may comprise forms created by the form application 72. The form application 72 may be comprise the form application discussed above in FIG. 1 and may be configured to dynamically control collisions of form controls in an electronic document. In accordance with various embodiments, the operating system 32 may be suitable for controlling the operation of a networked computer, such as the WINDOWS operating systems from MICROSOFT CORPORATION of Redmond, Wash. The mass storage device 14 is connected to the CPU 8 through a mass storage controller (not shown) connected to the bus 10. The mass storage device 14 and its associated computer-readable media provide non-volatile storage for the computer 2. The term computer-readable media as used herein may include computer storage media. Computer storage media may include volatile and nonvolatile, removable and non-removable media implemented in any method or technology for storage of information, such as computer readable instructions, data structures, program modules, or other data. Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by the computer 2. Any such computer storage media may be part of the computer 2.

The term computer-readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

According to various embodiments, the computer 2 may operate in a networked environment using logical connections to remote computers through the network 4 which may comprise, for example, a local network or a wide area network (e.g., the Internet). The computer 2 may connect to the network 4 through a network interface unit 16 connected to the bus 10. It should be appreciated that the network interface unit 16 may also be utilized to connect to other types of networks and remote computing systems. The computer 2 may also include an input/output controller 22 for receiving and processing input from a number of input types, including a keyboard, mouse, pen, stylus, finger, and/or other means. Similarly, an input/output controller 22 may provide output to a display device, a printer, or other type of output device. Additionally, a touch screen can serve as an input and an output mechanism.

Although the invention has been described in connection with various illustrative embodiments, those of ordinary skill in the art will understand that many modifications can be made thereto within the scope of the claims that follow. Accordingly, it is not intended that the scope of the invention in any way be limited by the above description, but instead be determined entirely by reference to the claims that follow.

1. A computer-implemented method of dynamically controlling collisions of form controls in an electronic document, comprising:
displaying, by a computer, a user interface comprising a design surface for manipulating the form controls in the electronic document;
receiving, by the computer, a selection of at least one form control from among the form controls in the electronic document;
moving, by the computer, the selected at least one form control over the design surface; and
moving, by the computer, at least one non-selected form control away from the selected at least one form control when the selected at least one form control collides with the at least one non-selected form controls as the selected at least one form control is being moved over the design surface, the at least one non-selected form control being aligned to a hidden grid within the design surface after being moved, the hidden grid comprising a plurality of gutters vertically aligned gutters defining a first plurality of spaces and a plurality of columns defining a second plurality of spaces, the plurality of vertically aligned gutters separating the plurality of columns, the form controls being placed in the plurality of spaces defined by the plurality of columns and separated by the plurality of spaces defined by the plurality of gutters, the combination of the plurality of gutters and the plurality of columns preventing the form controls from overlapping each other and facilitating alignment of the form controls on the design surface.

2. The method of claim 1, further comprising returning the at least one non-selected form control to an original location on the design surface upon the selected at least one form control being moved from the original location.

3. The method of claim 1, wherein receiving, by the computer, a selection of at least one form control from among the form controls in the electronic document comprises receiving a selection of at least one of a label a text box, an image control, a web page control and a combo box.

4. The method of claim 1, wherein receiving, by the computer, a selection of at least one form control from among the form controls in the electronic document comprises simultaneously receiving a selection of a plurality of the form controls.

5. The method of claim 1, wherein moving, by the computer, the selected at least one of form control over the design surface comprises dragging the selected at least one form control over the hidden grid.

6. The method of claim 1, wherein moving, by the computer, at least one non-selected form control away from the selected at least one form control when the selected at least one form control collides with the at least one non-selected form control as the selected at least one form control is being moved over the design surface comprises determining that the selected at least one form control encroaches horizontally upon the at least one non-selected form control.

7. The method of claim 6, further comprising:
moving the at least one non-selected form control upwards on the design surface when the at least one non-selected form control is on an upper half of the at least one selected form control encroaching horizontally upon the at least one non-selected form control;
moving the at least one non-selected form control downwards on the design surface when the at least one non-selected form control is on a lower half of the at least one selected form control encroaching horizontally upon the at least one non-selected form control; and
moving the at least one non-selected form control downwards on the design surface when the at least one non-selected form control is a same size as the at least one selected control encroaching horizontally upon the at least one non-selected form control.

8. The method of claim 7, further comprising:
determining a lack of space on the design surface for upward movement when the at least one non-selected form control is on the upper half of the at least one selected form control encroaching horizontally upon the at least one non-selected form control; and
moving the at least one non-selected form control downwards on the design surface.

9. The method of claim 1, wherein moving, by the computer, at least one non-selected form control away from the selected at least one form control when the selected at least one form control collides with the at least one non-selected form control as the selected at least one form control is being moved over the design surface comprises determining that the selected at least one form control encroaches vertically upon the at least one non-selected form control.

10. The method of claim 9, further comprising moving the at least one non-selected form control in a direction opposite to a direction of the vertical encroachment of the selected at least one form control on the design surface.

11. The method of claim 10, wherein moving the at least one non-selected form control in a direction opposite to a direction of the vertical encroachment of the selected at least one form control comprises moving the at least one non-selected form control in an upward direction on the design surface in response to the selected at least one form control being moved in an downward direction on the design surface.

12. A computer system for dynamically controlling collisions of form controls in an electronic document, comprising:
a memory for storing executable program code; and
a processor, functionally coupled to the memory, the processor being responsive to computer-executable instructions contained in the program code and operative to:
display a user interface comprising a design surface for manipulating a plurality of the form controls in the electronic document, the design surface being aligned to a hidden grid; receive a simultaneous selection of a plurality of form controls in the electronic document;
drag the selected plurality of form controls over the design surface; and
move a plurality of non-selected form controls away from the selected plurality of form controls when the selected plurality of form controls collides with the plurality of non-selected form controls as the selected plurality of form controls is being dragged over the design surface, the plurality of non-selected form controls being aligned to a hidden grid within the design surface after being moved, the hidden grid comprising a plurality of gutters vertically aligned gutters defining a first plurality of spaces and a plurality of columns defining a second plurality of spaces, the plurality of vertically aligned gutters separating the plurality of columns, the form controls being placed in the plurality of spaces defined by the plurality of columns and separated by the plurality of spaces defined by the plurality of gutters, the combination of the plurality of gutters and the plurality of columns preventing the form controls from overlapping each other and facilitating alignment of the form controls on the design surface.

13. The computer system of claim 12, wherein the processor is further operative to return the plurality of non-selected form controls to an original location on the design surface upon the plurality of selected form controls being dragged from the original location.

14. The computer system of claim 12, the processor, in moving a plurality of non-selected form controls away from the selected plurality of form controls when the selected plurality of form controls collides with the plurality of non-selected form controls as the plurality of selected form controls is being dragged over the design surface, is further operative to:
determine that the plurality of selected form controls encroaches horizontally upon the plurality of non-selected form controls;
move the plurality of non-selected form controls upwards on the design surface when the plurality of non-selected form controls is on an upper half of the plurality of selected form controls encroaching horizontally upon the plurality of non-selected form controls;
move plurality of non-selected form controls downwards on the design surface when the plurality of non-selected form controls is on a lower half of the plurality of selected form controls encroaching horizontally upon the plurality of non-selected form controls;
move the plurality of non-selected form controls downwards on the design surface when the plurality of non-selected form controls is a same size as the plurality of selected form controls encroaching horizontally upon the plurality of non-selected form controls.

15. The computer system of claim 14, wherein the processor is further operative to:
determine a lack of space on the design surface for upward movement when the plurality of non-selected form controls is on the upper half of the plurality of selected form controls encroaching horizontally upon the plurality of non-selected form controls; and
move the plurality of non-selected form control downwards on the design surface.

16. The computer system of claim 12, wherein the processor, in moving the plurality of non-selected form controls away from the plurality of selected form controls when the plurality of selected form controls collides with the plurality of non-selected form controls as the plurality of selected form controls is being moved over the design surface, is further operative to:
determine that the plurality of selected form controls encroaches vertically upon the plurality of non-selected form controls; and
move the plurality of non-selected form controls in a direction opposite to a direction of the vertical encroachment of the plurality of selected form controls on the design surface.

17. A computer-readable storage medium, wherein the computer-readable storage medium does not include a transmission signal, the computer-readable storage medium comprising computer executable instructions which, when executed by a computer, will cause the computer to perform a method of dynamically controlling collisions of form controls in a form, the method comprising:
displaying a user interface comprising a design surface for manipulating the form controls in the form;
receiving a selection of at least one form control from among the form controls in the form;
dragging the selected at least one form control over the design surface;
moving at least one non-selected form control away from the selected at least one form control when the selected at least one form control collides with the at least one non-selected form controls as the selected at least one form control is being moved over the design surface, the at least one non-selected form control being on the design surface in the form, the at least one non-selected form control being aligned to a hidden grid within the design surface after being moved, the hidden grid comprising a plurality of gutters vertically aligned gutters defining a first plurality of spaces and a plurality of columns defining a second plurality of spaces, the plurality of vertically aligned gutters separating the plurality of columns, the form controls being placed in the plurality of spaces defined by the plurality of columns and separated by the plurality of spaces defined by the plurality of gutters, the combination of the plurality of gutters and the plurality of columns preventing the form controls from overlapping each other and facilitating alignment of the form controls on the design surface; and
returning the at least one non-selected form control to an original location on the design surface upon the selected at least one form control being moved from the original location.

18. The computer-readable storage medium of claim 17, wherein moving at least one non-selected form control away from the selected at least one form control when the selected at least one form control collides with the at least one non-selected form control as the selected at least one form control is being moved over the design surface comprises:
determining that the selected at least one form control encroaches horizontally upon the at least one non-selected form control;
moving the at least one non-selected form control upwards on the design surface when the at least one non-selected form control is on an upper half of the at least one selected form control encroaching horizontally upon the at least one non-selected form control;
moving the at least one non-selected form control downwards on the design surface when the at least one non-selected form control is on a lower half of the at least one selected form control encroaching horizontally upon the at least one non-selected form control; and
moving the at least one non-selected form control downwards on the design surface when the at least one non-selected form control is a same size as the at least one selected control encroaching horizontally upon the at least one non-selected form control.

19. The computer-readable storage medium of claim 18, further comprising:
determining a lack of space on the design surface for upward movement when the at least one non-selected form control is on the upper half of the at least one selected form control encroaching horizontally upon the at least one non-selected form control; and
moving the at least one non-selected form control downwards on the design surface.

20. The computer-readable storage medium of claim 17, wherein moving at least one non-selected form control away from the selected at least one form control when the selected at least one form control collides with the at least one non-selected form control as the selected at least one form control is being moved over the design surface comprises:
determining that the selected at least one form control encroaches vertically upon the at least one non-selected form control; and
moving the at least one non-selected form control in a direction opposite to a direction of the vertical encroachment of the selected at least one form control on the design surface.
